(19) United States
(12) Patent Application Publication
(10) Pub. No.: US 2016/0282271 A1
(43) Pub. Date: Sep. 29, 2016

(54) Method for the Optical Characterization of an Optoelectronic Semiconductor Material and Device for Carrying Out the Method

(71) Applicant: OSRAM OPTO SEMICONDUCTORS GMBH, Regensburg (DE)

(72) Inventors: Jens EBBECKE, Rohr in Niederbayern (DE); Siegmar KUGLER, Regensburg (DE); Tobias MEYER, Regensburg (DE); Matthias PETER, Regensburg (DE)

(21) Appl. No.: 15/030,553

(22) PCT Filed: Nov. 14, 2014
(86) PCT No.: PCT/EP2014/074655

§ 371 Date: Jun. 14, 2016

(30) Foreign Application Priority Data
Nov. 21, 2013 (DE) 10 2013 112 885.8

(51) Int. Cl. G01N 21/64; G01N 21/88; G01N 21/95

(52) U.S. Cl. CPC G01N 21/6489; G01N 21/9501; G01N 21/8851

(57) ABSTRACT

A method is provided for a full-area optical characterization of an optoelectronic semiconductor material which is provided for producing a plurality of optoelectronic semiconductor chips and which has a band gap which specifies a characteristic wavelength of the semiconductor material. The method includes full-area irradiating a major surface of the optoelectronic semiconductor material with light having an excitation wavelength which is less than the characteristic wavelength of the semiconductor material, with the full-area irradiating generating electron-hole pairs in the semiconductor material. The method further includes full-area detecting a recombination radiation having the characteristic wavelength which is emitted as a result of recombination of the electron-hole pairs from the major surface of the semiconductor material. A device for carrying out the method is also provided.

This patent application is a national phase filing under section 371 of PCT/EP2014/074655, filed Nov. 14, 2014, which claims the priority of German patent application 10 2013 112 885.8, filed Nov. 21, 2013, each of which is incorporated herein by reference in its entirety.

### TECHNICAL FIELD

A method for the optical characterization of an optoelectronic semiconductor material and an apparatus for carrying out the method are provided.

### BACKGROUND

In the production of optoelectronic semiconductor chips, such as e.g. light-emitting diode chips, it is necessary to examine the functional capability of said chips during manufacture and/or after completion. For this purpose, e.g. characterization processes can be used, in which whole epitaxial wafers or chip slices are measured serially by sample measurements and/or ultrasonic control. However, such process controls take a relatively long period of time owing to the serial processing of the individual chips and accordingly are cost-intensive. Therefore, where possible, an entire wafer is often not characterized and instead only selected chips or regions on a chip slice are examined in order to save time by such a random sample-like selection. However, in the case of some process controls, such random samples are not possible, so that in these cases all of the chips still have to be serially processed, which takes a considerable amount of time.

Furthermore, e.g. in the case of types of chips which are contacted via a conductive substrate, the problem exists that directly after separation from the wafer composite, said chips are typically arranged on electrically insulating carriers, so that the underside of the chip is electrically insulated and therefore no functional control can be carried out via electrical contact.

Furthermore, in the case of epitaxially grown wafers and chips, there are a series of morphological features which can only be detected with difficulty or cannot be detected at all using conventional methods.

### SUMMARY

At least one embodiment provides a method for the optical characterization of an optoelectronic semiconductor material. At least one embodiment provides an apparatus for carrying out the method.

Some of the embodiments are achieved by a method and an article according to the independent claims. Advantageous embodiments and developments of the method and of the article are characterized in the dependent claims and are also apparent from the following description and the drawings.

According to at least one embodiment of the method, an optoelectronic semiconductor material is characterized in an optical manner. In particular, the method is provided for the full-area optical characterization of an optoelectronic semiconductor material which is provided for producing a plurality of optoelectronic semiconductor chips.

The semiconductor material is preferably formed by a semiconductor layer sequence for optoelectronic semiconductor chips. Such semiconductor layer sequences are typically grown on growth substrate wafers, are provided with electrical contact layers and are separated into individual optoelectronic semiconductor chips. As described further below, the method described in this case can be carried out directly after the growth or after a subsequent method step. The optoelectronic semiconductor chips can be formed e.g. as light-emitting diodes with or in the form of light-emitting diode chips which have an active layer which emits light during operation of the semiconductor chip. Furthermore, the optoelectronic semiconductor chips can also be photodiode chips which have an active layer which is suitable for converting light into electrical charges. By virtue of the fact that the optoelectronic semiconductor material is grown epitaxially on a growth substrate wafer, it has a planar formation with a major surface facing towards the growth substrate and a major surface facing away from the growth substrate, which major surfaces are formed perpendicularly with respect to the growth direction of the semiconductor layers and thus in parallel with the main extension planes of the semiconductor layers. The major surfaces are characterized in particular by virtue of the fact that the extension of the semiconductor material along the direction in parallel with the major surfaces is substantially larger than the extension perpendicular thereto, i.e. substantially larger than the thickness of the semiconductor material.

Full-area optical characterization is understood here and hereinafter to be a characterization method, in which not only individual regions of a plane in parallel with the major surfaces of the optoelectronic semiconductor material are examined but also the semiconductor material can be characterized at the same time over an entire major surface using optical means. Since the optoelectronic semiconductor material is provided for producing a plurality of optoelectronic semiconductor chips, it is thus possible with the full-area optical characterization described in this case for the plurality of optoelectronic semiconductor chips to be examined in parallel in a completed form or even in an as yet uncompleted form.

In particular, the optoelectronic semiconductor material can be a III-V-compound semiconductor material. A III-V-compound semiconductor material comprises at least one element of the third main group, e.g. B, Al, Ga, In, and one element from the fifth main group, e.g. N, P, As. In particular, the term III-V-compound semiconductor material includes the group of binary, ternary and quaternary compounds which contain at least one element from the third main group and at least one element from the fifth main group, e.g. a nitride, phosphide or arsenide compound semiconductor material. Such a binary, ternary or quaternary compound can also comprise e.g. one or a plurality of dopants as well as additional components.

For example, the semiconductor material can comprise a semiconductor layer sequence on the basis of InGaAlN. InGaAlN-based semiconductor chips, semiconductor materials and semiconductor layer sequences include in particular those, in which the epitaxially produced semiconductor layer sequence generally comprises a layer sequence which consists of different individual layers and contains at least one individual layer which comprises a material from the III-V-compound semiconductor material system InₓAl_{y}Ga_{1-x-y}N where 0≦x≦1, 0≦y≦1 and x+y≦1. Semiconductor layer sequences which comprise at least one active layer on the basis of InGaAlN can emit or detect e.g. preferably electromagnetic radiation in an ultraviolet to green wavelength range.

Furthermore, the semiconductor material can comprise a semiconductor layer sequence on the basis of InGaAlP. That is to say that the semiconductor layer sequence can comprise different individual layers, of which at least one individual layer comprises a material from the III-V-compound semiconductor material system InₓAl_{y}Ga_{1-x-y}P where 0≦x≦1, 0≦y≦1 and x+y≦1. Semiconductor layer sequences or semiconductor chips which comprise at least one active layer on the basis of InGalP can emit or detect e.g. preferably electromagnetic radiation in a green to red wavelength range.

Furthermore, the semiconductor material can comprise a semiconductor layer sequence on the basis of other III-V-compound semiconductor material systems, e.g. an AlGaAs-based material, or the basis of a II-VI-compound semiconductor material system. In particular, an active layer which comprises an AlGaAs-based material can be suitable for emitting or detecting electromagnetic radiation in a red to infrared wavelength range.

Corresponding to the material selection, the optoelectronic semiconductor material has a band gap which specifies a characteristic wavelength of the semiconductor material. In particular, the semiconductor material can comprise a semiconductor layer sequence having an active layer which comprises a band gap which specifies a characteristic wavelength of the semiconductor material. Depending upon the material selection, the characteristic wavelength can be in particular in one of the aforementioned wavelength ranges. The characteristic wavelength can designate e.g. the highest-intensity wavelength, the average wavelength or the average wavelength—weighted by the individual spectral intensities—of the emission spectrum of the semiconductor material in the case of light-emitting diode chips or the absorption spectrum of the semiconductor material in the case of photodiode chips.

According to a further embodiment, the full-area optical characterization of the semiconductor material is effected through a major surface of the semiconductor material. This can mean in particular that for the purpose of optical characterization light is irradiated via the major surface onto the semiconductor material. Furthermore, light emitted from the same major surface of the semiconductor material can be detected for the purpose of optical characterization.

According to a further embodiment, the semiconductor material is applied on a carrier. The major surface of the semiconductor material, through which the characterization of the semiconductor material is effected, can be formed preferably by the major surface of the semiconductor material facing away from the carrier. The carrier can be formed e.g. by means of a substrate wafer.

If the method described in greater detail hereinafter is carried out with a semiconductor material which is arranged on the growth substrate wafer, then the major surface of the semiconductor material can be formed by the surface of the grown semiconductor layer sequence facing away from the growth substrate wafer. Furthermore, after epitaxial growth of the semiconductor material, it is also possible to apply the semiconductor material to a carrier material, e.g. a carrier substrate wafer. The growth substrate wafer can then be thinned or removed, so that the major surface of the semiconductor material is formed by the surface of the semiconductor layer sequence facing away from the carrier substrate wafer. Furthermore, it is also possible for the carrier to be formed by a film or other material, on which the semiconductor material can be arranged with or without a substrate or substrate wafer as a whole or subdivided into functional regions. Depending upon the method stage in which the characterization method described in this case is carried out, the semiconductor material can be present as an epitaxial slice or chip slice with still contiguous or already separated semiconductor chips.

According to a further embodiment, in the case of the method for the full-area optical characterization of the optoelectronic semiconductor material the full area of the major surface of the optoelectronic semiconductor material is irradiated with light with an excitation wavelength which is less than the characteristic wavelength of the semiconductor material. This means that not only individual regions but at the same time the entire major surface of the optoelectronic semiconductor material are irradiated. In a particularly preferred manner, the major surface is irradiated over the full area and in a homogeneous manner, i.e. at an intensity which is uniform over the major surface, with the light with the excitation wavelength. In particular, the excitation wavelength is selected in such a manner that electron-hole pairs can be generated in the semiconductor material, in particular in an active layer. This means that the photons of the light with the excitation wavelength comprise an energy which is sufficient to generate electron-hole pairs in the semiconductor material.

Furthermore, the excitation wavelength is selected in such a manner that the smallest possible proportion of the excitatory light is absorbed in semiconductor layers of the semiconductor material, in which no electron-hole pairs can or should be generated. Such layers can be present in addition to an active layer in a semiconductor layer sequence forming the semiconductor material, and can be formed e.g. as so-called confinement layers. Such layers, in contrast to the active layer formed by a direct semiconductor material, often comprise indirect semiconductor materials. In the case of nitride semiconductor materials, such confinement layers can be formed e.g. by GaN layers, in the case of phosphide semiconductor materials said layers can be formed by InAlP layers and in the case of arsenide semiconductor materials said layers can be formed by AlGaAs layers having a composition which is selected accordingly. The excitatory light thus preferably comprises an energy which is greater than the band gap of the active layer of the semiconductor material and less than the band gap of the confinement material.

For example, the excitation wavelength can be 10 nm to 50 nm shorter than the characteristic wavelength of the semiconductor material. If the characteristic wavelength of the semiconductor material is in the blue to green spectral range, e.g. for blue to green emitting or detecting InGaN layers, the excitation wavelength can thus preferably be in the ultraviolet spectral range. If the characteristic wavelength of the semiconductor material is in the yellow to red spectral range, e.g. for yellow to red, i.e. approximately yellow, orange, amber or red, emitting or detecting InGaAlP layers, the excitation wavelength can thus preferably be in the green spectral range. If the characteristic wavelength of the semiconductor material is in the infrared spectral range, e.g. for arsenide layers, the excitation wavelength can thus preferably be in the near-infrared spectral range.

The electron-hole pairs formed by the light with the excitation wavelength in the optoelectronic semiconductor material recombine after a short period of time, whereby light with the characteristic wavelength can be emitted e.g. via the major surface. A further method step effects full-area detection of the recombination radiation with the characteristic wavelength which is emitted as a result of recombination of the electron-hole pairs from the major surface of the semiconductor material. In this case, full-area detection means that at the same time recombination radiation is detected which is emitted via the entire major surface of the semiconductor material. The steps involved in the full-area irradiation and the full-area detection can preferably be carried out at the same time, wherein the irradiation and the detection take place on the same side of the semiconductor material.

In the case of a fixedly specified illumination intensity of the light with the excitation wavelength, the emission light intensity of the semiconductor material, i.e. the intensity of the recombination radiation, is given by the efficiency and out-coupling of the semiconductor material and by the number of defects, e.g. shunts. Therefore, statements regarding the quality of the semiconductor material can be provided by the luminous density of the recombination radiation emitted via the major surface of the semiconductor material.

According to a further embodiment, the recombination radiation is detected by means of a detector, e.g. by means of a camera. The camera can take in particular an image of the entire major surface of the semiconductor material which is illuminated by the recombination radiation. Therefore, the camera can be used to record the quality of the entire epitaxial slice or chip slice, which is formed by the semiconductor material, at one go for each image. Preferably, the image is evaluated in a computer-assisted manner, so that the entire active surface of the semiconductor material can be established in parallel and not only consecutively in different regions. For this purpose, an analyzing unit can be provided which facilitates the computer-assisted evaluation of the image. The method described in this case thus offers a parallel structure for process and quality control. This provides a very inexpensive parallel method for process control and quality assurance.

According to a further embodiment, the semiconductor material is applied on a carrier which is formed by means of a substrate wafer, e.g. a growth substrate wafer or a carrier substrate wafer. The semiconductor material can be characterized on the substrate wafer using the method described directly after the epitaxial growth. Furthermore, it is also possible that e.g. after the epitaxial growth, electrode layers and/or further functional layers, e.g. passivation layers, are applied and the semiconductor material is then characterized. The semiconductor material can be present in a contiguous manner and over a large area. This means that in particular an active layer of the semiconductor layer sequence, which forms the semiconductor material, is not subdivided into individual functional regions when the method described in this case is carried out.

As an alternative thereto, it is also possible that in the case of the method described in this case, the semiconductor material is subdivided into functional regions which are at least partially separate from one another. For example, an at least partial subdivision of the semiconductor material into functional regions can be achieved by means of etching, in particular mesa etching. The subdivision into separate function regions can be performed in particular prior to the step of irradiating using the light with the excitation wavelength. The separate functional regions can be characterized by virtue of the fact that the active layer of the semiconductor layer sequence forming the semiconductor material is severed at least partially or completely. The subsequently completed optoelectronic semiconductor chips can be defined by the functional regions. By virtue of the full-area irradiation and the full-area detection, it is possible to detect the recombination radiation of all of the functional regions at the same time.

Furthermore, it is also possible for the semiconductor material to be divided up into functional regions which are completely separate from one another and which form parts of the subsequently completed optoelectronic semiconductor chips. The functional regions which are completely separate from one another can be arranged in particular on a common carrier, e.g. on a so-called adhesive frame, i.e. an adhesive film, by means of which the individual functional regions can be held and transported together after the semiconductor material has been divided up. In particular, prior to being completely divided up, the semiconductor material can be arranged on such a common carrier and can then be separated into the functional regions. The semiconductor material can be completely divided up in a particularly preferred manner by laser-separation, e.g. after a previous step of at least partially separating the semiconductor material. For example, the laser-separation can be performed directly before the described characterization method and thus in particular before the full-area irradiation of the major surface of the semiconductor material with the excitatory light. In this case, it can also be feasible for laser-separation and optical characterization to be performed in accordance with the previous description in the same apparatus, that is to say that in the apparatus for carrying out the method described in this case, e.g. a wafer comprising the optoelectronic semiconductor material is inserted, divided up and then measured.

According to at least one embodiment, an apparatus which is used to carry out the method for the full-area optical characterization of the optoelectronic semiconductor material comprises an illumination source for generating the light with the excitation wavelength and a detector for detecting the recombination radiation. The illumination source and the detector are preferably both arranged over the same major surface of the semiconductor material. Furthermore, the apparatus can also comprise a holder for the semiconductor material.

The embodiments and features described above and below apply in equal measure to the method and the apparatus.

According to a further embodiment, the illumination source is arranged above the semiconductor material. In this case, the term “above” means that the illumination source is arranged over the semiconductor material such that the light with the excitation wavelength can be irradiated onto the major surface of the semiconductor material. Preferably, the illumination source is formed in an annular manner and comprises an opening through which the recombination radiation can pass to a detector, e.g. a camera, which is arranged in or over the opening. In particular, the light with the excitation wavelength can be generated by a plurality of light-emitting diodes which are arranged in an annular manner above the semiconductor material.

Furthermore, optical filters can be used in order to optically separate the excitation light and the recombination radiation. For example, the illumination source, e.g. a plurality of light-emitting diodes, can have an optical short-pass filter disposed downstream thereof which is transmissive to the light with the excitation wavelength and not transmissive to the recombination radiation. The recombination radiation can be detected by means of an optical long-pass filter which is not transmissive to the light with the excitation wavelength and transmissive to the recombination radiation. The optical long-pass filter is arranged in particular between the detector and the semiconductor material, so that only recombination radiation can impinge upon the detector.

### BRIEF DESCRIPTION OF THE DRAWINGS

Further advantages, advantageous embodiments and developments are apparent from the exemplified embodiments described below in conjunction with the figures.

In the figures:

FIG. 1 shows a schematic view of an apparatus which is used for carrying out a method for the full-area optical characterization of an optoelectronic semiconductor material, in accordance with one exemplified embodiment,

FIGS. 2A to 2C show schematic views of semiconductor materials in accordance with further exemplified embodiments, and

FIGS. 3A and 3B show schematic views of an apparatus which is used for carrying out a method for the full-area optical characterization of an optoelectronic semiconductor material, in accordance with a further exemplified embodiment.

In the exemplified embodiments and figures, like or similar elements or elements acting in an identical manner may each be provided with the same reference numerals. The illustrated elements and their size ratios with respect to each other are not to be considered as being to scale; rather individual elements, such as e.g. layers, components, devices and regions, can be illustrated excessively large for improved clarity and/or for improved understanding.

### DETAILED DESCRIPTION OF ILLUSTRATIVE EMBODIMENTS

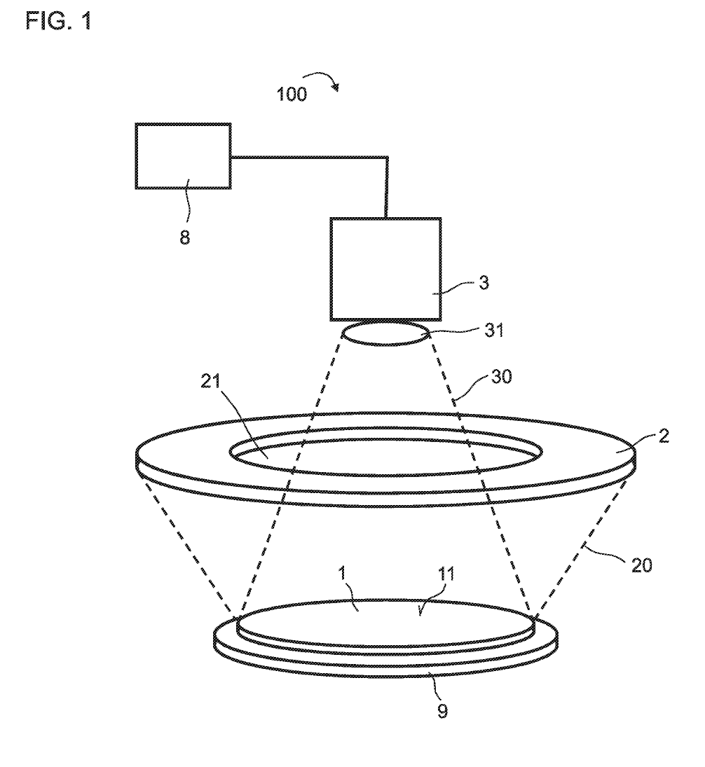

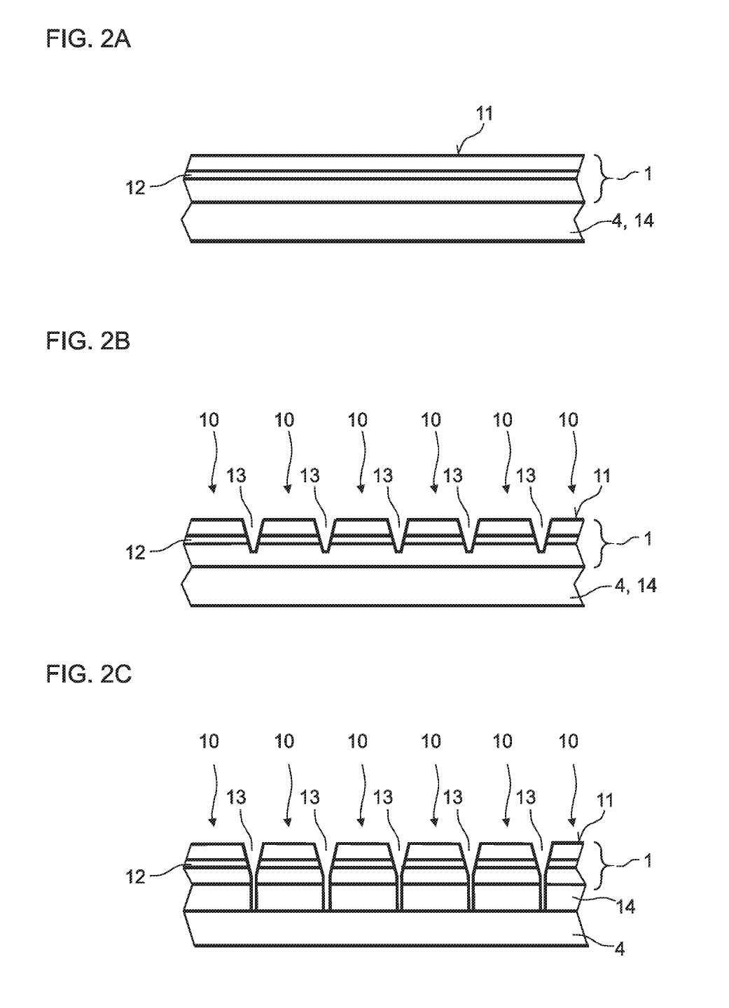

FIG. 1 shows an apparatus 100 which is used for carrying out a method for the full-area optical characterization of an optoelectronic semiconductor material 1. The optoelectronic semiconductor material 1 is provided for producing a plurality of optoelectronic semiconductor chips. In particular, the optoelectronic semiconductor material 1 can be present as a so-called epitaxial slice or chip slice and can comprise a band gap which specifies a characteristic wavelength of the semiconductor material 1, as described in conjunction with FIGS. 2A to 2C. As described in the general part, e.g. a semiconductor layer sequence on the basis of InₓGa_{y}Al_{1-x-y}As is suitable for an infrared to red radiation, e.g. a semiconductor layer sequence on the basis of InₓGa_{y}Al_{1-x-y}P is suitable for red to yellow radiation and e.g. a semiconductor layer sequence on the basis of InₓGa_{y}Al_{1-x--y}N is suitable for shortwave, visible, i.e. in particular green to blue radiation, where 0≦x≦1 and 0≦y≦1 apply in each case.

The semiconductor material 1 is arranged in the apparatus 100 by means of a holder 9, e.g. a substrate holder or other suitable support surface.

Furthermore, the apparatus 100 comprises an illumination source 2 for generating a light with an excitation wavelength which is less than the characteristic wavelength of the semiconductor material. For example, the excitation wavelength can be 10 nm to 50 nm less than the characteristic wavelength of the semiconductor material. The illumination source 2 is arranged over the holder 9 and thus over the semiconductor material 1.

Furthermore, the apparatus 100 comprises a detector 3 for detecting a recombination radiation 30 which is emitted during the recombination of electron-hole pairs in the semiconductor material 1 which, in turn, are generated in the semiconductor material 1 by the light 20 with the excitation wavelength. The illumination source 2 and the detector 3 are both arranged together over a major surface 11 of the semiconductor material 1.

In the case of the method for the full-area optical characterization of the optoelectronic semiconductor material 1, as carried out by the apparatus 100, the full area of the major surface 11 of the optoelectronic semiconductor material is irradiated with the light 20 with the excitation wavelength, in order to generate over the full area electron-hole pairs in the semiconductor material 1 in a plane in parallel with the major surface 11, in particular in an active layer of the semiconductor material 1. The detector 3 is configured to detect, over the full area, the recombination radiation 30 which is emitted by the semiconductor material 1 via the major surface 11 and has the characteristic wavelength. In particular, the detector 3 can comprise, or can be designed as, a camera which can take an image of the entire semiconductor material 1 or of the entire major surface 11 of the semiconductor material 1 illuminated by the recombination radiation 30. In order to achieve both full-area illumination by means of the illumination source 2 and full-area detection by means of the detector 3, the illumination source 2 is preferably formed in an annular manner and comprises an opening 21, through which the detector 3 can detect the recombination radiation 30. For this purpose, the detector 3 is arranged in or, as shown in FIG. 1, over the opening 21 of the illumination source 2 and preferably centrally with respect thereto. Therefore, the detector 3 is positioned centrally over the semiconductor material 1 and in particular the major surface 11 thereof and should have a resolution which is as high as possible in order to be able to record the local luminous density of the recombination radiation 30 on the entire major surface 11.

For example, the illumination source 2 can comprise a plurality of light-emitting diodes which emit the light 20 with the excitation wavelength and which are arranged, distributed around the opening 21, on the side of the illumination source 2 facing towards the semiconductor material 1. In this case, the illumination source 2 can be formed as a circular ring, as shown in FIG. 1. Furthermore, other geometries and ring-like shapes of the illumination source 2 are also possible. In particular, the illumination source 2 is formed in such a manner that the most homogeneous possible illumination of the semiconductor material 1 is achieved and that direct reflections of the light 20 with the excitation wavelength onto the detector 3 are avoided. In order to achieve an energetic separation of excitation light 20 and recombination radiation 30, the detector 3 can comprise e.g. a long-pass filter 31 which is transmissive to the recombination radiation and not transmissive to the light 20 with the excitation wavelength. In addition, the illumination source 2 can comprise an optical short-pass filter which is transmissive to the light 20 with the excitation wavelength and not transmissive to the recombination radiation 30.

In the case of a fixedly specified illumination intensity by reason of the light 20 with the excitation wavelength, the emission light intensity of the recombination radiation 30 is given by the efficiency and the out-coupling of the semiconductor material 1 and by the number of shunts in the semiconductor material 1. As a result, statements regarding the quality of the semiconductor material 1 can be provided by the luminous density of the recombination radiation 30. The full-area illumination and the full-area detection can be used to establish the quality of the entire semiconductor material 1 at one go for each image, in that the recorded image is then evaluated in a computer-controlled manner in a correspondingly provided analyzing unit 8. This provides an inexpensive and parallel method for the process control and quality assurance of the semiconductor material 1.

For a characteristic wavelength of the optoelectronic semiconductor material 1 in the blue to green spectral range the excitation wavelength can preferably be in the ultraviolet spectral range, for a characteristic wavelength of the semiconductor material 1 in the yellow to red spectral range the excitation wavelength can preferably be in the green spectral range, and for a characteristic wavelength of the semiconductor material 1 in the infrared spectral range the excitation wavelength can preferably be in the near-infrared spectral range.

FIGS. 2A to 2C show various exemplified embodiments of the semiconductor material 1 which illustrate various examples of manufacturing stages in the production of optoelectronic semiconductor chips. The previous described method can be carried out in each of the manufacturing stages shown as well as in manufacturing stages which take place chronologically therebetween.

In the exemplified embodiments shown, the semiconductor material 1 is formed by a semiconductor layer sequence which is arranged on a carrier 4 and which comprises an active layer 12 with a band gap which determines the characteristic wavelength of the semiconductor material 1 and thus the emission or absorption spectrum thereof depending upon the design of the semiconductor chips, which are to be produced, as light-emitting diode chips or photodiode chips.

In FIG. 2A, the semiconductor material 1 is present as a so-called epitaxial slice directly after the growth and is applied on a substrate wafer 14 in the form of a growth substrate wafer. In particular, the semiconductor layer sequence forming the semiconductor material 1 can be grown on the growth substrate wafer by means of an epitaxy method, e.g. by means of metalorganic vapor phase epitaxy (MOVPE) or molecular beam epitaxy (MBE). Furthermore, the semiconductor layer sequence can be provided with electrical contacts.

As an alternative thereto, the carrier 4 which is formed as a substrate wafer 14 can also be formed as a carrier substrate wafer, onto which the semiconductor material 1 has been transferred after the growth on a growth substrate wafer.

The semiconductor material 1 and in particular the active layer 12 are formed in an unstructured and continuous manner on the carrier 4. A plurality of the semiconductor chips can be provided by means of subsequent separation of the substrate wafer 14 comprising the grown semiconductor layer sequence. On the side facing away from the carrier 4, the semiconductor material 1 comprises the major surface 11, by means of which, as previously described, the light 20 with the excitation wavelength is irradiated and by means of which the recombination radiation 30 to be detected is emitted.

The semiconductor material 1 can comprise as the active layer 12 e.g. a conventional p-n junction, a double heterostructure, a single quantum well structure (SQW structure) or a multiple quantum well structure (MQW structure). The semiconductor material 1 can comprise, in addition to the active layer 12, further functional layers and functional regions, for instance p- or n-doped charge carrier transport layers, undoped or p- or n-doped confinement, cladding or waveguide layers, barrier layers, planarization layers, buffer layers, protective layers and/or electrode layers and combinations thereof. Furthermore, one or a plurality of reflective layers can be applied e.g. between the semiconductor material 1 and the carrier 4. For the sake of clarity, FIGS. 2A to 2C do not show the layers present in addition to the active layer 12.

FIG. 2B shows a further exemplified embodiment of the semiconductor material 1 which, in comparison with the exemplified embodiment of FIG. 2A, is subdivided into functional regions 10 which are partially separate from one another. For this purpose, separating trenches 13 are produced in the semiconductor material 1 e.g. by means of etching, for instance mesa etching, said separating trenches defining the functional regions 10 and separating same at least partially from one another. The functional regions 10 correspond to the subsequently completed semiconductor chips and thus constitute parts of the semiconductor chips. As shown in FIG. 2B, in the case of the separate functional regions 10, in particular the active layer 12 of the semiconductor layer sequence forming the semiconductor material 1 can be severed. As a result, it is possible to prevent charge carrier drifts of the electron-hole pairs between the individual functional regions 10, which are caused by the current expansion properties of the semiconductor material 1, so that it is possible to ensure that the recombination radiation which is emitted by a functional region 10 is also generated by electron-hole pairs which have been generated in this functional region 10. As in the exemplified embodiment of FIG. 2A, the carrier 4 can be e.g. a substrate wafer 14 which is formed by a growth substrate wafer or a carrier substrate wafer.

FIG. 2C shows a further exemplified embodiment illustrating a chip slice which is to be analyzed by means of the previously described method. In comparison with the two previous exemplified embodiments, the semiconductor material 1 is divided up into functional regions which are completely separate from one another. In this case, the separating trenches 13 extend not only through the semiconductor material 1 but also through the substrate carrier 14. The functional regions 10 which are completely separate from one another are arranged on a common carrier 4 which is formed by a so-called adhesive frame, i.e. an adhesive film, by means of which the separated functional regions 10 are held in the composite.

The semiconductor material 1 is completely divided up preferably by laser-separation, wherein this can be preceded by an etching step, as described in conjunction with FIG. 2. In particular, the functional regions 10 can form already completed semiconductor chips.

In the exemplified embodiments of FIGS. 2B and 2C, on the image of the recombination radiation 30 taken by the detector 3 as previously described in FIG. 1, the functional regions 10 appear as bright regions which are separated from one another by the separating trenches 13 which appear dark in color, so that in these cases it is possible to perform a characterization of the optoelectronic semiconductor material 1 which is precise in terms of the functional region and therefore in terms of the chip.

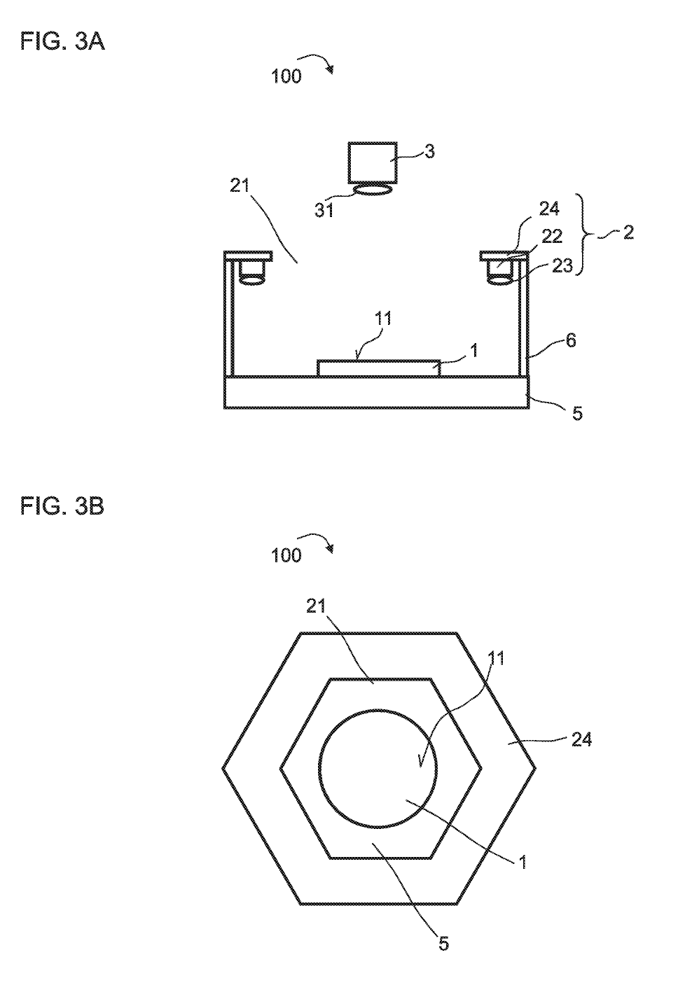

FIGS. 3A and 3B show a further exemplified embodiment of an apparatus 100 which is used for carrying out the method described e.g. in conjunction with FIGS. 1 to 2C. In this case, the semiconductor material 1 is arranged in a box which is formed by a base element 5, which forms or comprises a holder (not shown) for the semiconductor material 1, and by a wall 6, is open at the top towards the detector 3 and permits shadowing with respect to the ambient light. FIG. 3A shows a schematic sectional view, whereas FIG. 3B shows a top view of the box, which is formed by the base element 5 and the wall 6 and has the semiconductor material 1 arranged therein, from the view of a detector 3 arranged thereabove.

Regions of the inner surface of the base element 5 and/or the wall 6 can also be reflective, so that the light with the excitation wavelength which is emitted by the illumination source 2 can be irradiated more efficiently onto the semiconductor material 1. Parts of the wall 6 are formed as a cover 24 on the side opposite to the base element 5, at which on the side directed to the semiconductor material 1, a plurality of light-emitting diodes 22 with short-pass filters 23 arranged downstream thereof are arranged as the illumination source 2. The light-emitting diodes 22 are arranged around an opening 21 of the illumination source 2. As can be seen in FIG. 3B, the illumination source 2 and the opening 21 in the illumination source 2, through which the recombination radiation can be detected by the detector 3, are formed in an annular manner having a hexagonal shape. As an alternative thereto, other geometries are also possible.

The short-pass filters 23 are each transmissive to the light with the excitation wavelength and not transmissive to the recombination radiation. As an alternative to a plurality of short-pass filters 23, a correspondingly formed short-pass filter can also be arranged downstream of the complete set of light-emitting diodes 22.

The detector and the long-pass filter 31 are formed as described in conjunction with FIG. 1, wherein the long-pass filter 31 is transmissive to the recombination radiation and not transmissive to the light with the excitation wavelength.

The exemplified embodiments described in the figures can comprise, alternatively or in addition, further features as described in the general part.

The description made with reference to the exemplified embodiments does not restrict the invention to these embodiments. Rather, the invention encompasses any new feature and any combination of features, including in particular any combination of features in the claims, even if this feature or this combination is not itself explicitly indicated in the claims or exemplified embodiments.

1-20. (canceled)

21. A method for a full-area optical characterization of an optoelectronic semiconductor material which is provided for producing a plurality of optoelectronic semiconductor chips and which has a band gap which specifies a characteristic wavelength of the semiconductor material, the method comprising:
full-area irradiating a major surface of the optoelectronic semiconductor material with light having an excitation wavelength which is less than the characteristic wavelength of the semiconductor material, the full-area irradiating generating electron-hole pairs in the semiconductor material;
full-area detecting a recombination radiation having the characteristic wavelength which is emitted as a result of recombination of the electron-hole pairs from the major surface of the semiconductor material.

22. The method according to claim 21, wherein the semiconductor material is applied on a carrier which is formed by a substrate wafer.

23. The method according to claim 21, wherein the semiconductor material is subdivided into functional regions which are at least partially separate from one another.

24. The method according to claim 21, wherein the semiconductor material is divided into functional regions which are completely separate from one another and which are arranged on a common carrier.

25. The method according to claim 24, wherein the dividing is performed by laser-separation.

26. The method according to claim 21, wherein each functional region of the semiconductor material is part of an optoelectronic semiconductor chip.

27. The method according to claim 21, wherein the recombination radiation is detected by a camera which takes an image of the entire major surface of the semiconductor material, the major surface lighting up due to the recombination radiation.

28. The method according to claim 27, wherein the image is evaluated using computer-assisted evaluation.

29. The method according to claim 21, wherein the characteristic wavelength of the semiconductor material is in the blue to green spectral range and the excitation wavelength is in the ultraviolet spectral range.

30. The method according to claim 21, wherein the characteristic wavelength of the semiconductor material is in the yellow to red spectral range and the excitation wavelength is in the green spectral range.

31. The method according to claim 21, wherein the characteristic wavelength of the semiconductor material is in the infrared spectral range and the excitation wavelength is in the near-infrared spectral range.

32. The method according to claim 21, wherein the light having the excitation wavelength is generated by a plurality of light-emitting diodes which have an optical short-pass filter arranged downstream therefrom, wherein the optical short-pass filter is transmissive to the light with the excitation wavelength and is not transmissive to the recombination radiation.

33. The method according to claim 21, wherein the recombination radiation is detected using an optical long-pass filter which is not transmissive to the light having the excitation wavelength and is transmissive to the recombination radiation.

34. An apparatus which is used for carrying out a method according to claim 21, comprising:
a holder for the semiconductor material,
an illumination source for generating the light having the excitation wavelength,
a detector for detecting the recombination radiation,
wherein the illumination source and the detector are both arranged above a major surface of the semiconductor material.

35. The apparatus according to claim 34, wherein the illumination source is arranged above the semiconductor material and comprises an opening, through which the recombination radiation can pass to the detector.

36. The apparatus according to claim 34, wherein the illumination source is formed in an annular arrangement.

37. The apparatus according to claim 34, wherein the illumination source comprises a plurality of light-emitting diodes and an optical short-pass filter arranged downstream from the plurality of light emitting diodes, wherein the optical short-pass filter is transmissive to the light having the excitation wavelength and is not transmissive to the recombination radiation.

38. The apparatus according to claim 34, wherein the detector comprises a camera configured to an image of the entire major surface of the semiconductor material and detect the major surface lighting up due to the recombination radiation.

39. The apparatus according to claim 38, further comprising an analyzing unit for evaluating the image using a computer-assisted evaluation.

40. The apparatus according to claim 34, wherein an optical long-pass filter is arranged between the detector and the semiconductor material and is not transmissive to the light having the excitation wavelength and transmissive to the recombination radiation.
